(19) United States
(12) Patent Application Publication
(10) Pub. No.: US 2003/0108643 A1
(43) Pub. Date: Jun. 12, 2003

(54) System and method for packaging meat products in low oxygen environment

(76) Inventors: Walter Hornsby, Woodstock, GA (US); Jim Trost, New Berlin, WI (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/279,501

(22) Filed: Oct. 24, 2002

Related U.S. Application Data
(60) Provisional application No. 60/335,042, filed on Oct. 24, 2001.

(51) Int. Cl. A23B 4/00

(52) U.S. Cl. 426/129

(57) ABSTRACT

A tray for packaging meat product at a centralized meat packaging facility and transporting the package meat product in a low oxygen environment to a retail point of sale. Centralized packaging of meat products for distribution to remote retail establishments requires techniques to prolong the shelf life of the meat product. Trays according to certain embodiments of the present invention have side walls terminating in a lip and a downturned flange. A notch is formed in the flange adjacent to a groove formed in the lip of the tray. The meat is placed in the tray at the centralized meat packaging facility and sealed with a film having perforations. The packaged meat is transported to the retail establishment in a low oxygen environment. Once the packaged meat reaches the retail establishment, it may be exposed to atmospheric oxygen which passes through the perforations of the film, the notch, and the groove causing the meat product to turn red, which is desirable to consumers.

### RELATED APPLICATION

This application claims the benefit of U.S. Provisional Application No. 60/335,042 filed on Oct. 24, 2001, which is incorporated herein by reference.

### FIELD OF THE INVENTION

This invention relates to containers and methods for packaging food products, and more particularly to products and processes for packaging meat products in regionalized or centralized processing facilities for subsequent shipment to retail sale establishments.

### BACKGROUND

Consumers of meat products are always concerned with the freshness of the product prior to making a purchase. Most consumers discern the freshness of the product by the appearance, or color, of the product prior to making a purchase. In the past, retail establishments, such as supermarkets, have butchered meat and packaged meat products at the point of sale. For example, a supermarket may receive a side of meat from a slaughterhouse, and have its butchering staff butcher the side of meat into individual steaks, ground beef, or other selective cuts of meat and then package the meat in styrene foam trays with a clear film wrapping for display and sale. This approach meets the requirements for conventional meat packaging and shipping logistics. However, each supermarket or other point of sale must have a meat department where the meat is butchered and packaged. Having such a meat department in every store is inefficient and costly.

Attempts to streamline conventional methods of meat processing for more economic efficiency have resulted in centralized meat processing facilities and distribution logistics. It may be preferable to butcher and package the meat in a central facility, which benefits from economies of scale, and thereafter ship the butchered meat products to supermarkets or other retail outlets. Centralized packaging provides the advantages of proper waste disposal and, possibly, improved sanitation.

Problems with centralized packaging of meat arise because consumers prefer to buy meat which is red in color as a result of oxygen exposure. The general consumer believes that the fresher the product, the better it is, and that red colored meat is most fresh. Conventional methods of packaging meat at a centralized facility for sale at retail locations involve a high oxygen packaging method and vacuum packaging of meat. The high oxygen method of packaging meat products requires exposing the meat product to high concentrations of oxygen in the package, which assists in maintaining the red color. The meat is shipped in the high oxygen environment to the retail store. At the retail establishment, the meat product is displayed and remains red for a limited time, after which it turns brown which may be undesirable to consumers.

The vacuum packaging method of centralized meat packaging, which is further described below, involves placing the meat product in a vacuumed sealed bag immediately after it is cut, and is still purple. Because the meat is exposed to low levels of oxygen, it remains purple while in the package. The meat is displayed for sale in the vacuum package. Consumers may find the purple meat color undesirable, although the meat will turn red once the package is opened and the meat product is exposed to oxygen.

The primary functions of meat packaging are to: (1) protect against physical and chemical change of the product, (2) protect against microbes, and (3) to present the product to the consumer in an attractive manner. Meat products are typically packaged in one of three types of packages, which are overwrap, vacuum sealed and modified atmospheric packaging (M.A.P.) in a rigid tray. Overwrap packaging uses an expanded polystyrene tray with a clear PVC film overwrap. Vacuum packaging involves individual packaging of meat products by placing the meat in a clear packaging material, removing the air from the package and sealing the package. This seals the meat product in a vacuum, eliminating the possibility of the meat reacting with the oxygen, as described above.

There are two types of M.A.P. packaging used with rigid trays: high oxygen atmosphere and low oxygen atmosphere. As stated earlier, in the high oxygen package the meat is shipped red in the sealed tray with approximately 80 percent oxygen and 20 percent carbon dioxide. The shelf life for this system lasts for several days depending on the type of meat in the package. In a low oxygen package the meat is shipped in an atmosphere of carbon dioxide with very small traces of oxygen. In this low oxygen environment the meat is purple in color. Once the package reaches the retail store, the packaged product is exposed to oxygen and it blooms red. This process significantly extends shelf life over a high oxygen packaging system.

Previous attempts to package meat in a low oxygen atmosphere have included the use of Styrofoam trays. Typically, the freshly butchered meat product is placed in the Styrofoam tray and sealed with a film. The package is flushed with preservation-enhancing gas mixture. However, residual oxygen may be trapped in the porous openings of the Styrofoam tray and, over time, diffuse out into the package containing the meat product and cause premature blooming and discoloration of the meat.

### SUMMARY

The invention provides a method and a tray for atmospheric packaging of meat products. The tray is formed from molded plastic, for example, polypropylene, polystyrene, APET, CPET or any other suitable plastic material. The tray provides vertical ribs in the side walls for added strength. The side walls terminate in a lip with a downwardly extending flange at the top of the tray. One or more grooves and a notch trimmed in the flange are located along the lip of the tray.

The film used to seal the tray is perforated to allow gas exchange with the packaged meat. The perforations in the film are preferably located in the portion of the film partially covering the sides of the tray. The grooves and the notch trimmed flange of the tray further promote the gas exchange with the meat product inside the tray.

In order to seal the tray, the tray is placed inside a sleeve of clear film. The sleeve is hermetically sealed at each end, with the tray inside. Heat is applied to the tray and sleeve which shrinks the film around the tray. The ends of the sleeve may be folded down to give an overwrap type appearance, similar to the appearance of meat cut and packaged at the retail establishment.

Generally stated, the present invention provides a tray and method for packaging fresh meat and provides a prolonged shelf life. According to one aspect of the present invention, meat is butchered at a centralized meat packaging facility and placed in a tray for packaging. The tray may be placed in a clear film sleeve with perforations and sealed at each end. One or more such trays are placed in an outer bag, which is impervious to oxygen. Prior to sealing the outer bag, it is first evacuated to low oxygen levels and then gas flushed with a preservation enhancing gas. The outer bag is then immediately sealed. The perforations of the film and the grooves located in the tray are essential to reducing the amount of oxygen in the package to the required low levels.

After being sealed inside the outer bag, the meat product can be shipped from the centralized facility to the retail establishments. Due to the impermeability of the outer bag to oxygen and the oxygen free atmosphere inside the bag, the meat product is exposed to only low levels of oxygen and does not bloom. Thus, the meat product may be transported over great distances, even to remote locations without jeopardizing the salability of the meat.

Once the packaged meat arrives at the retail location, the outer bag is opened and the individual packaged trays are removed. This allows oxygen to enter through the perforations of the film and the grooves in combination with the notch trimmed flange causing the meat to change, or bloom, into the desired red color. In this condition, the meat packages are ready for display at the retail location.

The present invention may also be used in modified atmospheric packaging of meat products using a high oxygen content. The meat product is placed in the tray of the present invention for packaging. The meat in the tray is evacuated of its normal atmosphere. The packaged meat is then gas flushed with oxygen, allowing the meat to retain its red color. While this creates a desirable visual impression for the consumer, the shelf life of the meat product may be reduce significantly.

An advantage of using the present invention to ship meat using the low oxygen method is that the trays may be more completely filled, allowing more meat to be shipped per unit volume.

It should be understood that the present invention may also be useful in providing meat product to grocery delivery service establishments that operate via the internet or wireless networks. Such services may experience a need for even greater shelf life of meat products. It may not be necessary to subject the meat product to oxygen and allow for the subsequent blooming until just prior to the delivery to the consumer.

Another aspect of the invention allows for easier denesting of a stack of trays during high speed package of meat products at a centralized facility. During the automated high speed packaging process, stacks of trays are automatically fed into a tray feeding device. A key aspect to achieve needed efficiency of this high speed meat packaging process is the ability to feed trays at a high speed onto a conveyor without multiple trays being fed at a single time. This is accomplished by providing trays with asymmetrical comer regions with lugs that prevent the vacuuming effect otherwise present in stacked trays.

It is therefore an object of the present invention to provide a tray and method for packaging meat products that adequately prolongs the shelf life of meat products to take advantage of the efficiencies of centralized meat packaging and distribution chain logistics.

It is another object of the present invention to provide a tray and method for packaging meat products that prolongs the shelf life of meat products until the product is ready for sale by the retailer.

It is another object of the present invention to provide a tray and method for packaging meat products that prevents the discoloration of meat products prior to displaying the meat products for sale.

It is a further object of the present invention to provide a tray and method for packaging meat products that prevents the meat products exposure to oxygen until the product is ready for display and sale by a retailer.

It is yet another object of the present invention to provide a tray and method for packaging meat products that allows for enhanced gas exchange with the packaged meat product.

It is still another object of the present invention to provide a tray and method for packaging meat products that allows for meat to be distributed from a centralized packaging facility to retail establishments in a manner that is more efficient.

Other objects, features and advantages of the present invention will become apparent from the following description of the invention when taken in conjunction with the accompanying drawings.

### BRIEF DESCRIPTION OF THE DRAWINGS

FIG. 1 is a top plan view of a tray according to the present invention.

FIG. 2 is a side plan view of the tray of FIG. 1.

FIG. 3 is a side perspective view of the tray of FIG. 1.

FIG. 4 is a top plan view of a tray according to the present invention with two curved side walls.

FIG. 5 is a side plan view of the tray of FIG. 4.

FIG. 6 is an end plan view of the tray of FIG. 4.

FIG. 7 is a top plan view of a tray according to the present invention with shallow side walls.

FIG. 8 is a side plan view of the tray of FIG. 7.

FIG. 9 is an end plan view of the tray of FIG. 7.

FIG. 10 is a top plan view of a tray according to the present invention with shallow side walls and two curved side walls.

FIG. 11 is a side plan view of the tray of FIG. 10.

FIG. 12 is a side plan view of the tray of FIG. 10.

FIG. 13 is a top plan view of the tray of FIG. 10 sealed using a film.

FIG. 14 is a side plan view of the tray of FIG. 10 sealed using a film.

FIG. 15 is a side plan view of a plurality of sealed trays in an outer bag.

### DETAILED DESCRIPTION

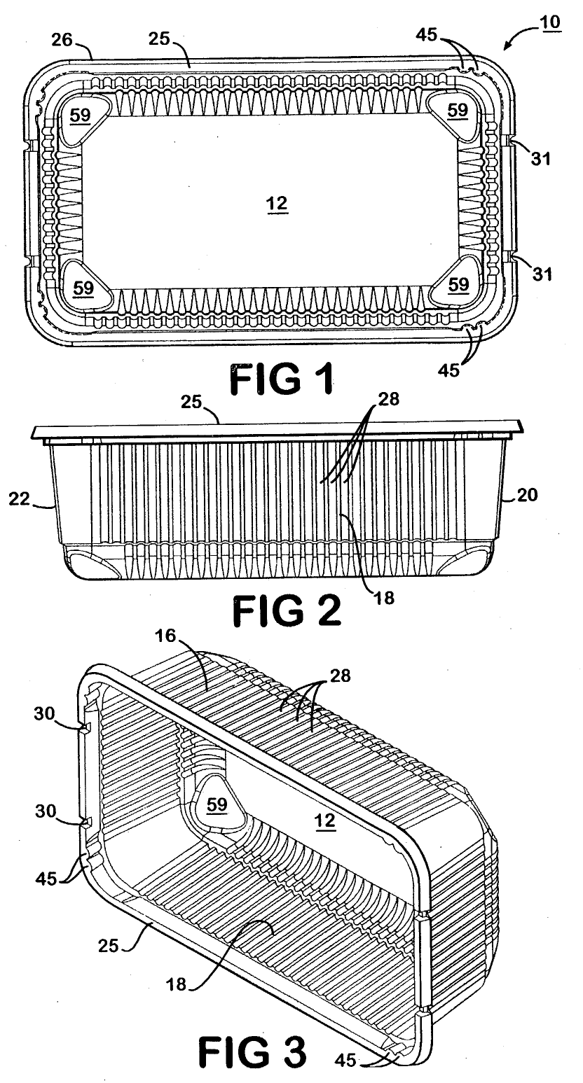

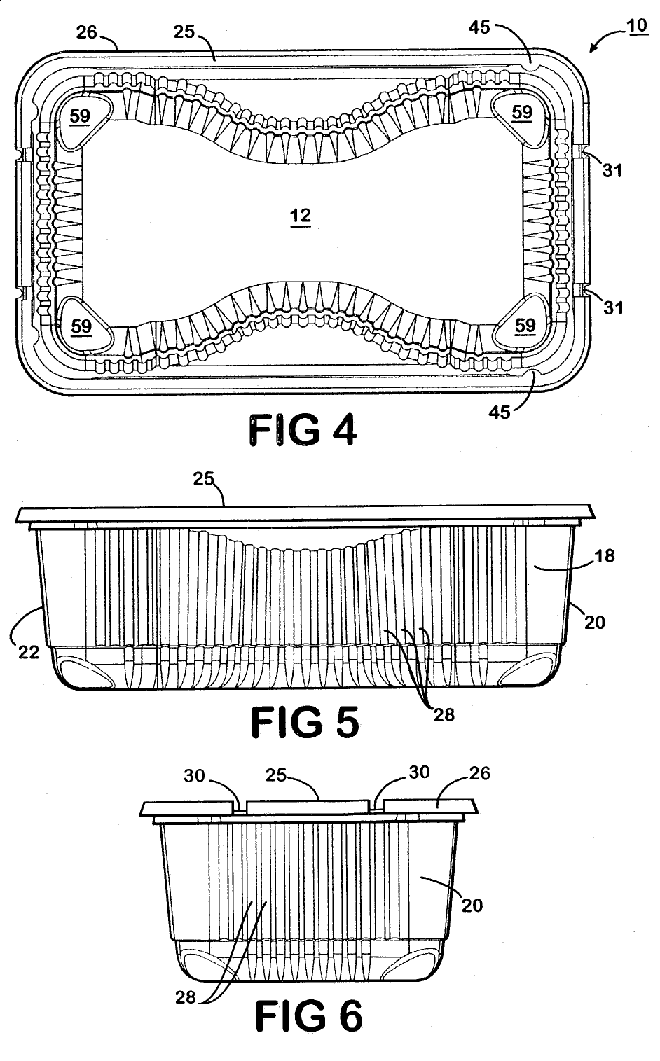

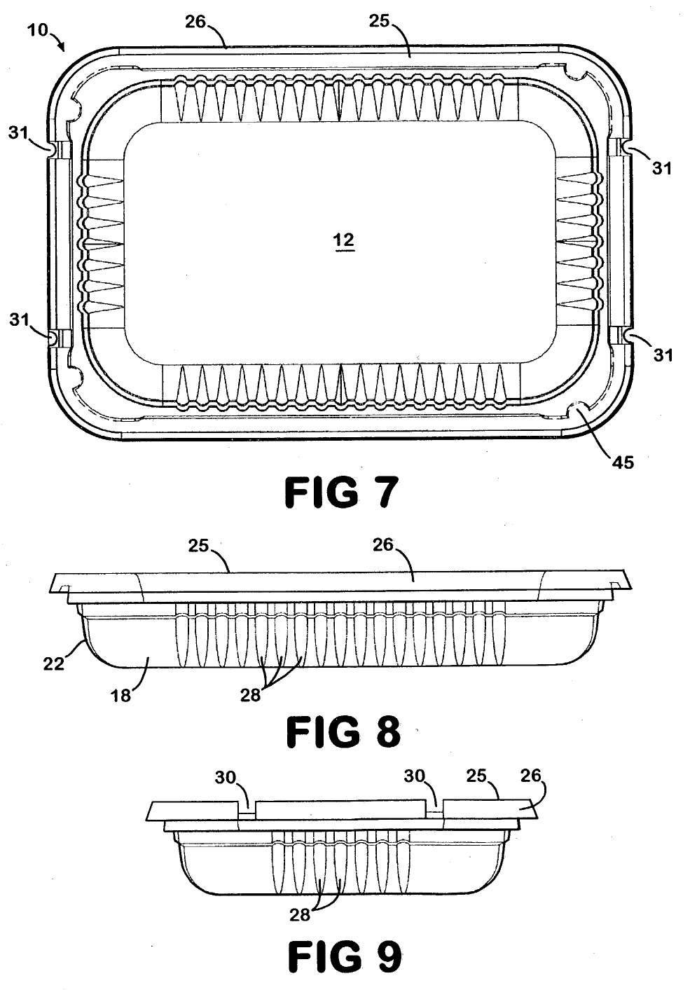

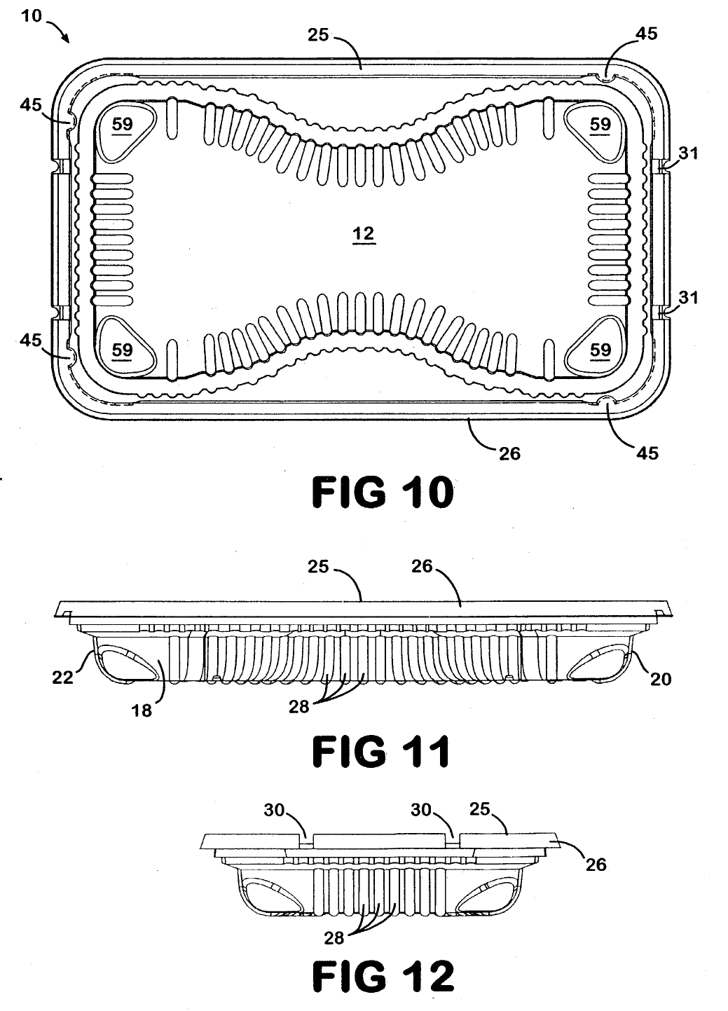

Referring now to the drawings in which like numerals refer to like parts throughout the several views, FIG. 1 shows a tray 10 for packaging meat. The tray is formed from molded plastic, such as polypropylene or any other suitable plastic material. The tray is preferably made of material which is impermeable to oxygen and does not retain residual oxygen, forming a gas barrier. The tray has a bottom surface 12 and four side walls 16, 18, 20, 22 extending upward from the bottom surface forming the tray, as shown in FIG. 3. Each of the side walls is slightly angled outwardly. The side walls may vary in height and may also be curved without departing from the scope of the invention, as show in FIGS. 4-12. A lip 25 with a downturned flange 26, attached to the top of the side walls, extends around the periphery of the tray.

The lip serves as a handle for lifting the tray and provides rigidity and support at the top of the tray. Strength in the flange prevents bowing of the tray when placing the film on the tray. The trays are sealed using an OSSID machine. This involves belts gripping the sides of the trays and feeding the tray into the film sleeve. The reinforced flange prevents significant deformation of the tray during this step. It should be understood that the present lip structure is but one embodiment of the present invention and other suitable lip structures may be used with the tray of the present invention without departing from the spirit of the invention.

A plurality of vertical ribs 28 are located in each of the side walls, extending around the perimeter of the tray. The number of ribs in each wall is dependent upon the overall size of the tray. The ribs provide increased strength to the side walls of the tray. This can reduce damage to the tray from impact and prevents deflection and bending of the tray during the automated meat packaging process.

The ribs also provide increased rigidity without a corresponding increase in weight of the tray. This provides the benefit of lowering the manufacturing costs of the trays as well as the reduction of weight of the tray. These advantages provide substantial savings in both material and shipping costs.

Chamfers 59 are located in the bottom comers of the tray. During the thermoforming process of the trays, the comers of the trays may be stretched thin. This may cause less plastic material to be associated with the comer regions of the trays. The chamfers allow more plastic material to be associated with the comer regions of the tray, providing increased strength to the tray.

Grooves 30 are located in the lip, as shown in FIGS. 1 and 3. The grooves are formed by cut-outs in the lip. The grooves are shown as rectangular, but can be of any shape. While the grooves shown in FIGS. 1 and 3 are located at opposite ends of the tray, it should be understood that the grooves may be positioned at any location along the lip of the tray. The lip 25 terminates in the flange 26 extending around the perimeter of the tray. Notches 31 are located in the flange adjacent to the grooves 30. The grooves along with the notch trimmed flange provide a passageway for gas to travel through as further described herein.

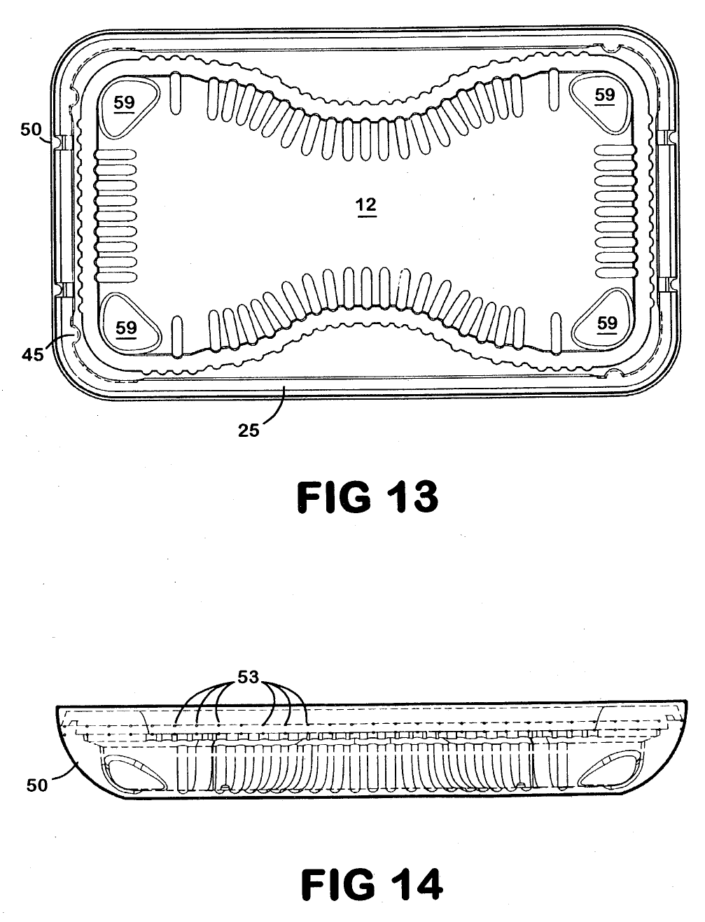

The trays are used to package meat products at a central meat packaging facility and subsequent distribution at retail locations. The meat products are prepared into select cuts at the central meat packaging facility. Trays according to the present invention are provided, typically in a high speed automated fashion as further described below. The meat products are placed inside the trays for packaging. The trays, filled with the meat products, are sealed using a clear film 50, as shown in FIGS. 13 and 14. The film may be in the form of a sleeve. The film encloses the entire tray and is sealed on each end. In order to seal the tray, the tray is placed in a film sleeve containing perforations 53 on the side portions. The sleeve is hermetically sealed at both ends. The sealed tray is passed through a heat tunnel so that the film shrinks around the tray. The ends of the sleeve may be folded down to give an overwrap appearance. The overwrap appearance is associated with freshness of the meat product by many customers. The film is perforated, preferably on the sides, to provide for gas transfer to the meat product as described below.

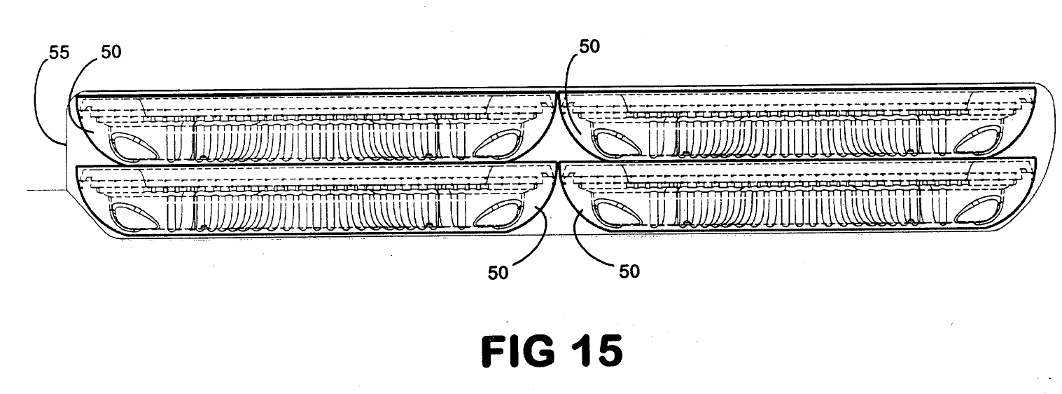

One or more sealed trays may be placed inside an outer bag. The trays are stacked inside the outer bag 55, as shown in FIG. 15. The outer bag is made from a material that is essentially impervious to oxygen. After placing the desired number of trays into the outer bag, the outer bag is vacuumed to evacuate all of the oxygen from the interior of the bag. It should be understood that the previous steps should be performed quickly to minimize the meat products exposure to oxygen and preventing the meat product from changing color prematurely.

The outer bag is then flushed with a preservation enhancing gas, such as carbon dioxide. The carbon dioxide prevents growth of bacteria associated with the meat product. The gas passes through the perforations located in the film on the sides of the package. The grooves in the tray and the notch trimmed flange provide a channel through which the gas may pass to the meat product. This allows the perforations to be located in the film on the sides of the tray, rather than the top. Film perforations located on the top of the tray may be blocked due to purge released by the meat product, particularly when several trays are stacked. As the grooves are located in the lip of the tray, they are not subject to being blocked by the meat product or purge. The outer bag is then sealed with the trays containing meat product inside.

The outer bag containing the packaged trays of meat product, is shipped from the centralized meat packaging facility to a retail establishment, such as a supermarket. It should be understood that the retail establishment could be any type of retail establishment that sells such products, including restaurants and grocery delivery services operated through the Internet or wireless services. After reaching the retail establishment, the retailer decides when the meat product is to be displayed or sold. The retailer opens the outer bag allowing atmospheric oxygen to enter the outer bag. The oxygen travels through the perforations of the film and through the grooves to the meat product. This is essentially the first exposure of the meat product to oxygen since being cut. The prolonged exposure to oxygen causes the meat to quickly change colors, or bloom, turning red. This is the color that the consumer typically associates with fresh meat product. Thus the meat product is ready for display and sale.

The combination of the notch and the groove provide the necessary passageway for gas transfer. The notch creates a vent between the film of the sealed tray and the groove. The notch is preferably 0.1875 inches wide and 0.1156 inches deep. The notch is preferably sized to prevent the film from sealing off the notch when the tray is sealed. The combination of the formed groove and the notch insures that the oxygen inside the tray is evacuated as described above, the preservation enhancing gas is not sealed off from reaching the meat product packaged in the tray, and the atmospheric oxygen is capable of reaching the meat product causing it to bloom at the retail point of sale.

In order to more efficiently package meat products at the centralized meat packaging facility, the trays are provided with asymmetrical corner regions. Lugs 45 located in the corner regions of the trays provide the asymmetry. The lugs are provided to discourage trays from snugly fitting together when stacked, creating a vacuum effect. When packaging meat using stacked trays with high-speed machinery, the vacuum effect causes the machines to select multiple trays rather than one tray leading to inefficiencies and jamming. The lugs of the present tray allow for mechanical selection of just one tray at a time, and reduces the jamming of the machinery.

Asymmetrical corners can be achieved by providing lugs in the corners of trays at different locations. Alternate location of the lugs is preferred. This pattern of the lug placement ensures that trays do not lock together when stacked. Another way to prevent the vacuum effect of stacked trays is to provide lugs of different shapes on different trays. This also prevents the stacked trays from sitting flush.

Packaging of meat products at a centralized facility is best achieved when feeding trays onto a conveyor at high speed. This is done by pulling individual trays from a stack, using a vacuum pickup, and placing the individual trays on the conveyor belt. Thus, it is important that containers stack loosely so that the vacuum arm can easily select a single tray. The trays of the present invention with asymmetrical comers insure ease of separation from a stack of trays. After the tray is placed on the conveyor belt, it is sent to the product filling station and then to the sealing station, prior to placement inside the outer bag for shipment.

What is claimed is:

1. A plastic tray for shipping case ready meat product from a centralized meat packaging facility to a retail point of sale, the tray comprising:
a bottom surface;
upstanding walls extending upward from the periphery of the bottom surface and terminating in a lip and a downturned flange;
at least one groove formed in the lip and at least one notch formed in the flange adjacent to the location of the groove; and
a seal covering the top and sides of the tray and comprising perforations on the portion of the seal covering the sides of the tray;
whereby the case ready meat is placed in the tray and sealed at the centralized meat packaging facility prior to blooming, is transported to the retail establishment in a low oxygen environment, and is exposed to atmospheric oxygen at the retail establishment, the oxygen passing through the perforations of the seal and the notch and groove causing the case ready meat to bloom and be visually appealing to consumers when placed in a display case at the retail point of sale.

2. The tray according to claim 1, wherein the tray is placed in a bag which is impervious to oxygen and preservation enhancing gas is injected into the bag, the preservation enhancing gas passing through the perforations of the seal and the notch and groove causing the case ready meat to be preserved during transportation from the centralized meat processing facility to the retail point of sale.

3. The tray according to claim 1, wherein the tray is sealed with a sleeve of clear film which is hermetically sealed at each end.

4. The tray according to claim 1, wherein the tray is sealed with a sleeve of clear film which is hermetically sealed at each end.

5. The tray according to claim 1, further comprising denesting lugs allowing the tray to easily separate from a stack of said trays at the centralized meat packaging facility.

6. The tray according to claim 5, wherein the denesting lugs are located in a different location on the tray than denesting lugs located on an adjacent tray in the stack.

7. The tray according to claim 5, wherein the denesting lugs are of a different shape than denesting lugs located on an adjacent tray in the stack.

8. A process of shipping case ready meat product from a centralized meat packaging facility to a retail point of sale, comprising:
placing the case ready meat product in a tray at the centralized meat packaging facility prior to blooming, the tray comprising a bottom surface;
upstanding walls terminating in a lip and a downturned flange; and
at least one groove formed in the lip and at least one notch formed in the flange adjacent to the location of the groove;
sealing the top and sides of the tray with a clear film comprising perforations on the portion of the film covering the sides of the tray;
transporting the tray and case ready meat to the retail establishment in a low oxygen environment;
exposing the tray to atmospheric oxygen at the retail establishment allowing the oxygen to pass through the perforations of the seal and the notch and groove causing the case ready meat to bloom and be visually appealing to consumers when placed in a display case at the retail point of sale.

9. The process according to claim 8, further comprising placing the tray in a bag which is impervious to oxygen injecting preservation enhancing gas into the bag, the preservation enhancing gas passing through the perforations of the seal and the notch and groove causing the case ready meat to be preserved during transportation from the centralized meat processing facility to the retail point of sale.

10. The process according to claim 8, further comprising hermetically sealing the tray at each end with the film.

11. The process according to claim 10, further comprising heating the tray and sleeve giving an overwrap appearance.

12. The process according to claim 8, wherein the tray comprises denesting lugs allowing the tray to easily separate from a stack of said trays at the centralized meat packaging facility.

13. The process according to claim 12, wherein the denesting lugs are located in a different location on the tray than denesting lugs located on an adjacent tray in the stack.

14. The process according to claim 12, wherein the denesting lugs are of a different shape than denesting lugs located on an adjacent tray in the stack.

15. A tray for packaging case ready meat product at a centralized meat packaging facility and transporting the packaged meat product to a retail point of sale in a low oxygen environment, the tray comprising:
a bottom surface;
upstanding walls surrounding the bottom surface and terminating in a lip and downturned flange;
grooves located in the lip and notches located in the flange adjacent to the grooves; and
a seal covering the top and sides of the tray and comprising perforations on the portion of the seal covering the sides of the tray;
whereby the tray is exposed to atmospheric oxygen at the retail establishment, the oxygen passing through the perforations of the seal and the notches and grooves causing the case ready meat to bloom and be visually appealing to consumers when placed in a display case at the retail point of sale.

16. The tray according to claim 15, wherein the tray is placed in a bag which is impervious to oxygen and preservation enhancing gas is injected into the bag, the preservation enhancing gas passing through the perforations of the seal and the notches and grooves causing the case ready meat to be preserved during transportation from the centralized meat processing facility to the retail point of sale.

17. The tray according to claim 15, wherein the tray is sealed with a sleeve of clear film which is hermetically sealed at each end.

18. The tray according to claim 17, wherein the tray is sealed with a sleeve of clear film which is hermetically sealed at each end.

19. The tray according to claim 15, further comprising denesting lugs allowing the tray to easily separate from a stack of said trays at the centralized meat packaging facility.

20. The tray according to claim 19, wherein the denesting lugs are located in a different location on the tray than denesting lugs located on an adjacent tray in the stack.

21. The tray according to claim 19, wherein the denesting lugs are of a different shape than denesting lugs located on an adjacent tray in the stack.

22. The tray according to claim 15, wherein the tray is formed from a rigid plastic material preventing residual oxygen from being trapped with in the body of the tray.
